(19) United States
(12) Patent Application Publication
(10) Pub. No.: US 2017/0013262 A1
(43) Pub. Date: Jan. 12, 2017

(54) RATE CONTROL ENCODING METHOD AND RATE CONTROL ENCODING DEVICE USING SKIP MODE INFORMATION

(71) Applicant: SAMSUNG ELECTRONICS CO., LTD., SUWON-SI (KR)

(72) Inventors: SUNGHO JUN, SUWON-SI (KR); SUNGJEI KIM, SEOUL (KR)

(21) Appl. No.: 15/205,042

(22) Filed: Jul. 8, 2016

(30) Foreign Application Priority Data
Jul. 10, 2015 (KR) 10-2015-0098632

(51) Int. Cl. H04N 19/124; H04N 19/577; H04N 19/593; H04N 19/146

(52) U.S. Cl. CPC H04N 19/124; H04N 19/146; H04N 19/577; H04N 19/593

(57) ABSTRACT

To improve image quality, a rate control encoding method using skip mode information is disclosed. The method includes calculating a skip mode occurrence frequency with respect to frames inside a window previous to a current window and comparing the calculated skip mode occurrence frequency with a reference value. In the case that the calculated skip mode occurrence frequency exceeds the reference value, an allocation number of bits with respect to an intra frame inside the current window is allocated to be more than an initial target number of bits and frames inside the current window are encoded. In the case that the calculated skip mode occurrence frequency does not exceed reference value, the allocation number of bits is allocated to be equal to the initial target number of bits and the frames inside the current window are encoded.

### CROSS-REFERENCE TO RELATED APPLICATIONS

This application claims priority under 35 U.S.C. §119 to Korean Patent Application No. 10-2015-0098632, filed on Jul. 10, 2015, in the Korean Intellectual Property Office, the disclosure of which is incorporated by reference herein in its entirety.

### BACKGROUND

The disclosure relates to video signal processing, and more particularly, to a rate control encoding method and a rate control encoding device using skip mode information.

Demand for a high resolution image and a high quality image such as an HD (high definition) image and a UHD (ultra high definition) image is being increased in various application fields these days.

Since as image data becomes high resolution and high quality, an amount of data relatively increases compared with existing image data, in the case of transmitting image data using a medium such as an existing wire/wireless wideband circuit or storing the image data using an existing storage medium, transmission cost and storage cost increase.

To solve those problems caused by high resolution and high quality of image data, high efficiency image compression techniques may be used.

As image compression techniques, there exist various techniques such as an inter-screen (inter-mode) prediction technique predicting a pixel value included in a current picture from a previous or next picture of the current picture, an intra-screen (intra mode) prediction mode predicting a pixel value included in a current picture using pixel information in the inside of the current picture, and a bit rate allocation technique adjusting a target number of bits of a frame. If effectively compressing image data using the aforementioned image compression technique, the image data can be transmitted or stored while minimizing image degradation of a picture group.

### SUMMARY

Embodiments of the disclosure provide a rate control encoding method using skip mode information. The rate control encoding method is executed by an encoder and includes calculating a skip mode occurrence frequency with respect to frames inside a window previous to a current frame. The calculated skip mode occurrence frequency is compared with a reference value. In the case that the calculated skip mode occurrence frequency exceeds the reference value, an allocation number of bits with respect to an intra frame inside the current window is allocated to be more than an initial target number of bits and the frames inside the current window are encoded. In the case that the calculated skip mode occurrence frequency does not exceed the reference value, an allocation number of bits with respect to the intra frame is allocated to be equal to the initial target number of bits and the frames inside the current window are encoded.

In embodiments of the disclosure, the frames in the previous window may include P frames or B frames.

In embodiments of the disclosure, the current window and the previous window may include a plurality of P frames, B frames, and intra frames.

In embodiments of the disclosure, the calculation of the skip mode occurrence frequency is performed after receiving scene change information.

In embodiments of the disclosure, a comparison of the calculated skip mode occurrence frequency and the reference value is executed by checking whether a result value obtained by adding an average of a skip mode occurrence frequency to a value obtained by multiplying the number of bits per block inside a frame by a given scaling factor exceeds a predetermined threshold value.

In embodiments of the disclosure, when the allocation number of bits is more than the initial target number of bits, a quantization parameter is lowered.

In embodiments of the disclosure, when the allocation number of bits is equal to the initial target number of bits, a quantization parameter is maintained at an initial setting value.

In embodiments of the disclosure, in the case that the calculated skip mode occurrence frequency exceeds the reference value, the allocation number of bits with respect to the intra frame inside the current window increases and an allocation number of bits with respect to other frames, except the intra frame inside the current window, decreases.

Embodiments of the disclosure also provide a rate control encoding device using skip mode information. The rate control encoding device may include a bit rate predictor that allocates all of a target number of bits with respect to a current window and a target number of bits of an intra frame. A processor calculates a skip mode occurrence frequency with respect to frames inside a window previous to the current window, compares the calculated skip mode occurrence frequency with a reference value, and allocates an allocation number of bits with respect to the intra frame inside the current window to be more than an initial target number of bits of the intra frame, in the case that the calculated skip mode occurrence frequency exceeds the reference value. An encoding rate controller generates a quantization parameter with respect to each block of frames inside the current window according to the allocation number of bits allocated by the processing control unit.

Embodiments of the disclosure also provide an encoding method executed by an encoding device. The method includes determining a skip mode occurrence frequency with respect to frames inside a window encoded previous to a current window. When the determined skip mode occurrence frequency exceeds a predetermined value, a number of bits for a frame inside the current window is allocated to be greater than a predetermined number of bits. Frames inside the current window are encoded using the allocated number of bits, when the determined skip mode occurrence frequency exceeds the predetermined value.

### BRIEF DESCRIPTION OF THE FIGURES

Preferred embodiments of the disclosure will be described below in more detail with reference to the accompanying drawings.

FIG. 1 is a block diagram illustrating a data processing system in accordance with exemplary embodiments of the disclosure.

FIG. 2 is a block diagram of an image communication system including the data processing system illustrated in FIG. 1.

FIG. 3 is a block diagram of a codec illustrated in FIGS. 1 and 2.

FIG. 4 is a detailed block diagram of the codec illustrated in FIG. 3.

FIG. 5 is a drawing explaining a target number of bits allocation method of a codec according to FIG. 4.

FIG. 6 is a flow chart of rate control encoding using skip mode information in accordance with exemplary embodiments of the disclosure.

FIG. 7 is a drawing explaining a quantization parameter control of a codec according to FIG. 4.

FIG. 8 is a flow chart of a skip mode occurrence check according to FIG. 6.

FIG. 9 is a block diagram explaining a path of screen change information according to FIG. 6.

FIG. 10 is a flow chart of a skip mode occurrence frequency calculation by frames according to FIG. 6.

FIG. 11 is a flow chart illustrating a comparison between the skip mode occurrence frequency calculation according to FIG. 6 and a reference value.

FIG. 12 is a block diagram of an encoder according to FIG. 2.

FIG. 13 is a block diagram of a decoder according to FIG. 2.

FIG. 14 is a drawing illustrating an application example applied to a disk driver connected to a computer system.

FIG. 15 is a drawing illustrating an application example of the disclosure applied to a content supply system.

FIG. 16 is a drawing illustrating an application example of the disclosure applied to a cloud computing system using an encoder and a decoder.

### DETAILED DESCRIPTION

Embodiments of disclosure will be described more fully hereinafter with reference to the accompanying drawings, in which embodiments of the disclosure are shown.

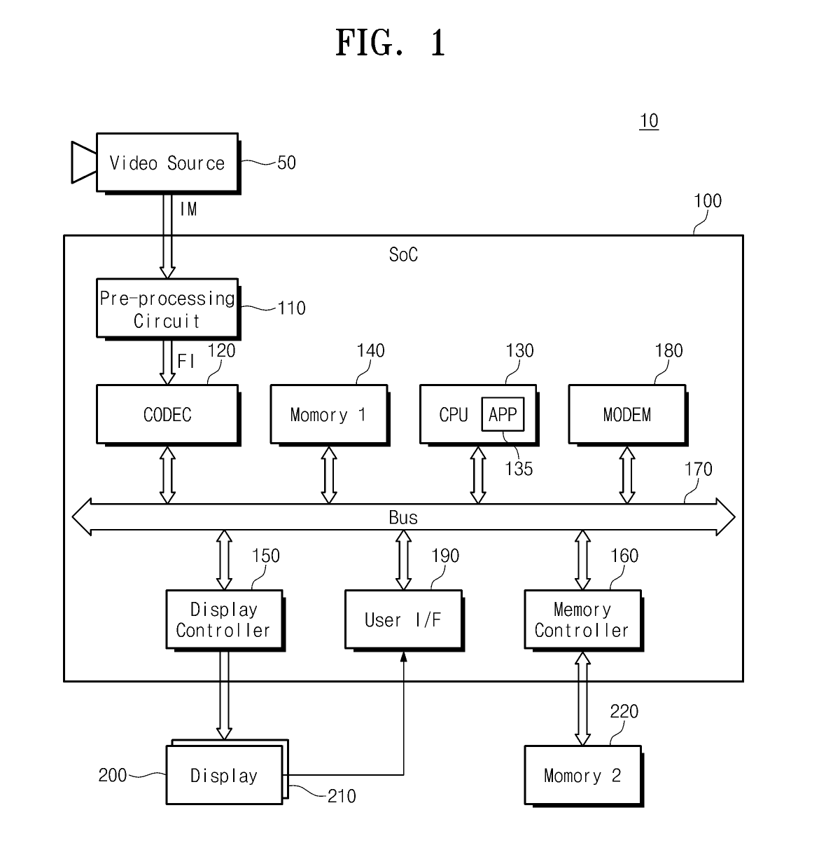

FIG. 1 is a block diagram illustrating a data processing system in accordance with exemplary embodiments of the disclosure.

Referring to FIG. 1, a data processing system 10 may be embodied by one of a television (TV), a DTV (digital TV), an IPTV (internet protocol TV), a PC (personal computer), a desk top computer, a lap-top computer, a computer workstation, a tablet PC, a video game platform (or video game console), a server and a mobile computing device.

The mobile computing device may be embodied by a cellular phone, a smart phone, a PDA (personal digital assistant), an EDA (enterprise digital assistant), a digital still camera, a digital audio camera, a PMP (portable multimedia player), a PND (personal navigation device or portable navigation device), a mobile internet device, a wearable computer, an IoT (internet of things) device, an IoE (internet of everything) device, or an e-book.

The data processing system 10 may mean a device capable of processing a 2D (dimensional) or 3D graphic data and displaying the processed data.

The data processing system 10 may include a video source 50, a system on chip (SoC) 100, a display 200, an input device 210 and a second memory 220. There is illustrated in FIG. 1 that the second memory 220 is outside the SoC 100. However, the disclosure is not limited thereto. The second memory 220 may be embodied inside the SoC 100.

The video source 50 may be embodied by a camera loaded with a CCD or CMOS image sensor. The video source 50 can shoot the subject, generate first data IM with respect to the subject, and provide the generated first data IM to the SoC 100. The first data IM may be still image data or video data.

The SoC 100 can control an overall operation of the data processing system 10. For instance, the SoC 100 may include an integrated circuit (IC), a mother board, an application processor (AP), or a mobile AP that can perform operations in accordance with exemplary embodiments of the disclosure. The SoC 100 can process first data IM output from the video source 50 and display the processed data through the display 200, store the processed data in the second memory 220 or transmit the processed data to another data processing system. The first data IM output from the video source 50 may be transmitted to a pre-processing circuit 110 through an MIPI® camera serial interface (CSI).

The SoC 100 may include the pre-processing circuit 110, a coder/decoder (codec) 120, a CPU 130, a first memory 140, a display controller 150, a memory controller 160, a bus 170, a modem 180, and a user interface 190.

The codec 120, the CPU 130, the first memory 140, the display controller 150, the memory controller 160, the modem 180, and the user interface 190 may exchange data with one another through the bus 170. The bus 170 may be embodied by at least one selected from a PCI (peripheral component interconnect) bus, a PCI express bus, an AMBA (advanced microcontroller bus architecture), an AHB (advanced high performance bus), an APB (advanced peripheral bus), an AXI (advanced extensible interface) bus, and combinations thereof. However, the disclosure is not limited thereto.

The pre-processing circuit 110 receives the first data IM output from the video source 50. The pre-processing circuit 110 can process the received first data IM and output second data FI generated according to a processed result to the codec 120. Each of the first data IM and the second data FI may mean a frame (or picture).

For convenience of description, each data (IM and FI) is called a current frame (or current picture).

The pre-processing circuit 110 may be embodied by an image signal processor (ISP). The ISP can transform the first data IM having a first data format into the second data FI having a second data format. The first data IM may be data having a bayer pattern and the second data FI may be YUV(YCbCr) data. However, the disclosure is not limited thereto. FIG. 1 illustrates that the pre-processing circuit 110 is embodied inside the SoC 100. However, the disclosure is not limited thereto. For example, the pre-processing circuit 110 may be embodied outside the SoC 100.

The codec 120 can perform an encoding operation with respect to each of a plurality of blocks included in the current frame FI.

The encoding operation may use an image data encoding technique such as a JPEG (joint picture expert group), an MPEG (motion picture expert group), an MPEG-2, an MPEG-4, a VC-1, an H. 264, an H. 265, or an HEVC (high efficiency video coding).

The codec 120 may be embodied by a hardware codec or a software codec. The software codec may be executed by the CPU 130.

The codec 120 performs rate control encoding using skip mode information capable of improving image quality of a picture group.

The CPU 130 can control an operation of the SoC 100.

A user input may be provided to the SoC 100 so that the CPU 130 executes one or more applications (e.g., software applications (APP) 135).

Any one of the applications 135 executed by the CPU 130 may mean an image conversion application. The application 135 executed by the CPU 130 may include an operating system (OS), a word processor application, a media player application, a video game application, and/or a graphic user interface (GUI) application. However, the disclosure is not limited thereto.

As the application 135 is executed, the first memory 140 can receive data encoded by the codec 120 to store the received data under the control of the memory controller 160. The first memory 140 can transmit data stored by the application 135 to the CPU 130 or the modem 180 under the control of the memory controller 160.

The first memory 140 can write data with respect to the application 135 executed in the CPU 130 and can read data with respect to the application 135 stored in the first memory 140.

The first memory 140 may be embodied by a volatile memory like an SRAM (static random access memory) or a nonvolatile memory like a ROM (read only memory).

The display controller 150 can transmit data output from the codec 120 or the CPU 130 to the display 200.

The display 200 may be embodied by a monitor, a TV monitor, a projection device, a TFT-LCD (thin film transistor-liquid crystal display), an LED (light emitting diode) display, an OLED (organic LED) display, an AMOLED (active-matrix OLED) display, or a flexible display.

The display controller 150 can transmit data to the display 200 through an MIPI display serial interface (DSI).

The input device 210 can receive a user input inputted from a user and can transmit an input signal which responds to the user operation to the user interface 190.

The input device 210 may be embodied by a touch panel, a touch screen, a voice recognizer, a touch pen, a keyboard, a mouse, a track point, etc., but the disclosure is not limited thereto. For instance, in the case that the input device 210 is a touch screen, the input device 210 may include a touch panel and a touch panel controller. In the case that the input device 210 is a voice recognizer, the input device 210 may include a voice recognizing sensor and a voice recognizing controller. The input device 210 may be in contact with the display 200 or may be separated from the display 200 to be embodied.

The input device 210 can transmit an input signal to the user interface 190.

The user interface 190 can receive an input signal from the input device 210 and can transmit data generated by the input operation to the CPU 130.

The memory controller 160 can read data stored in the second memory 220 and can transmit the read data to the codec 120 or the CPU 130 under the control of the codec 120 or the CPU 130. The memory controller 160 can also write data output from the codec 120 or the CPU 130 in the second memory 220 under the control of the codec 120 or the CPU 130.

The second memory 220 may be embodied by a volatile memory and/or a nonvolatile memory. The volatile memory may be embodied by a RAM (random access memory), an SRAM (static RAM), a DRAM (dynamic RAM), an SDRAM (synchronous DRAM), a T-RAM (thyristor RAM), a Z-RAM (zero capacitor RAM), or a TTRAM (twin transistor RAM).

The nonvolatile memory may be embodied by an electrically erasable programmable read-only memory (EEPROM), a flash memory, a magnetic random access memory (MRAM), a spin-transfer torque MRAM, a ferroelectric RAM (FeRAM), a phase change RAM (PRAM), or a resistive RAM (RRAM).

The nonvolatile memory may also be embodied by an MMC (multimedia card), an eMMC (embedded MMC), a UFS (universal flash storage), an SSD (solid state drive), a USB flash drive or an HDD (hard disk drive).

The modem 180 can output data encoded by the codec 120 or the CPU 130 to the output using a wireless communication technology. The wireless communication technology may mean a WI-FI, a WIBRO, a 3G wireless communication, an LTE (long term evolution), an LTE-A (long term evolution-advanced), or a broadband LTE-A.

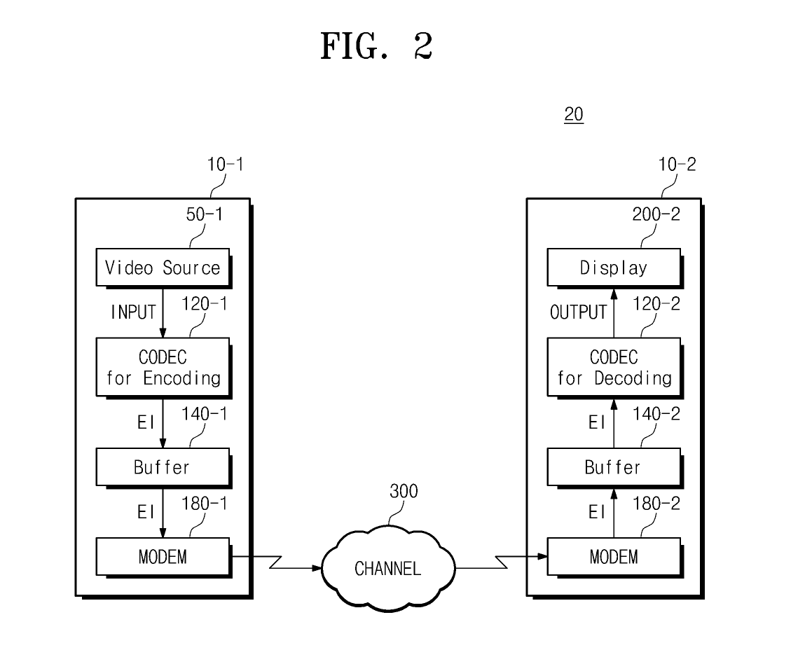

FIG. 2 is a block diagram of an image communication system including the data processing system illustrated in FIG. 1.

Referring to FIG. 2, the image communication system 20 may include a first data processing system 10-1 and a second processing system 10-2 capable of communicating with each other through a channel 300. The image communication system 20 may mean an image conversion system.

A structure and an operation of the first data processing system 10-1 may be the same as or similar to those of the second data processing system 10-2.

The first processing system 10-1 may include a video source 50-1, a codec 120-1, a buffer 140-1, and a modem 180-1.

The first data processing system 10-1 can encode data received from the video source 50-1 and transmit the encoded data EI to the second data processing system 10-2 through the channel 300.

The video source 50-1 may be substantially the same as the video source 50 illustrated in FIG. 1, the codec 120-1 may be substantially the same as the codec 120 illustrated in FIG. 1, the buffer 140-1 may be substantially the same as the buffer 140 illustrated in FIG. 1 and the modem 180-1 may be substantially the same as the buffer 180 illustrated in FIG. 1.

The second processing system 10-2 can receive the encoded data EI transmitted from the first processing system 10-1 through the channel 300.

The second processing system 10-2 may include a display 200-2, a codec 120-2, a buffer 140-2, and a modem 180-2.

The modem 180-2 can transmit the encoded data EI transmitted from the first data processing system 10-1 to the buffer 140-2. The modem 180-2 may be substantially the same as the modem 180 illustrated in FIG. 1.

The buffer 140-2 can receive the encoded data EI from the modem 180-2 and transmit the encoded data EI to the codec 120-2. The buffer 140-2 may be substantially the same as the buffer 140 illustrated in FIG. 1.

The codec 120-2 can decode the encoded data EI. For instance, the codec 120-2 may include a function of a decoder.

The display 200-2 can display the data decoded by the codec 120-2. The display 200-2 may be substantially the same as the display 200 illustrated in FIG. 1.

The first data processing system 10-1 and the second data processing system 10-2 can perform a bidirectional communication through the channel 300. The channel 300 may be a WI-FI, a WIBRO, a 3G wireless communication, an LTE (long term evolution), an LTE-A (long term evolution-advanced), or a broadband LTE-A.

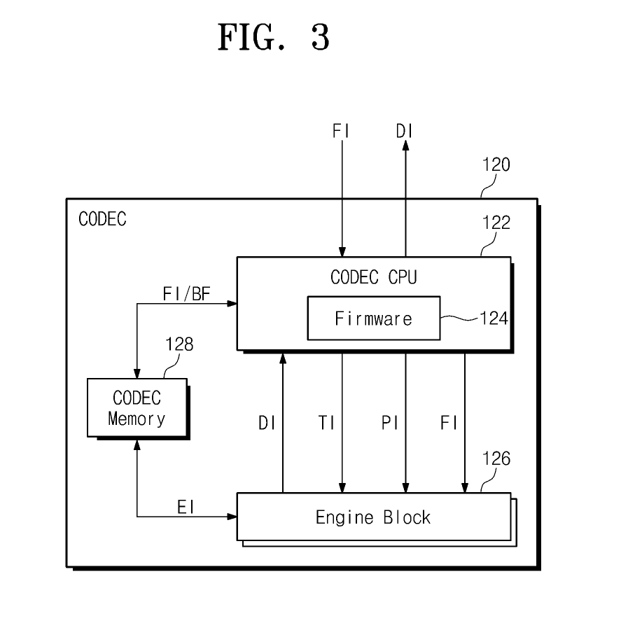

FIG. 3 is a block diagram of the codec illustrated in FIGS. 1 and 2.

Referring to FIG. 3, the codec 120 may include a codec central processing unit (CPU) 122, an engine block 126, and a codec memory 128.

The codec CPU 122 can control so that a current frame FI output from the pre-processing circuit 110 of FIG. 1 is stored in the codec memory 128.

The codec CPU 122 can function as a processing control unit, calculate a skip mode occurrence frequency with respect to frames inside a previous window of a current window and compare the calculated skip mode occurrence frequency with a reference value. Herein, the window may mean a GOP (group of pictures). In exemplary embodiments, the GOP may include at least one of an I-frame, a B-frame and a P-frame. For instance, among the frames included in the GOP, the first frame is the I-frame and the remaining frames may be the I-frame, the B-frame and/or the P-frame. The number of frames included in the GOP and the order of different types of frames transmitted from the pre-processing circuit 110 may be variously changed.

In a mobile device, in particular, when compressing an image in which an amount of movement is small, a skip mode occurs in a P-frame (prediction frame) or a B-frame (by prediction mode) many times. Thus, image quality of an I-frame which is the first frame among the frames included in the GOP forms a large part of the whole image quality of the GOP. To improve the image quality of the I-frame, an amount of bits allocated to the I-frame has to be increased by performing a rate control. If the amount of bits allocated to the I-frame becomes greater than an initial target amount of bits, the engine block 126 can generate a relatively low quantization parameter QP by each block of the I-frame. Thus, image quality of the I-frame becomes relatively high.

When processing a still image that occurs in an image conversion, skip mode information that occurs in a P-frame or a B-frame may be used as a factor of a bit rate control when allocating a bit with respect to an I-frame of a current window. The skip information may be skip information with respect to a block unit inside a frame. One frame may be comprised of a plurality of blocks or slices.

A target number of bits with respect to an I-frame (intra frame) is needed to be allocated within a range not exceeding a marginal capacity of a buffer for reception. Because if an amount of bits of the I-frame increases enough to exceed a marginal capacity of the buffer for reception, a frame drop may occur.

If maximally allocating bits to the I-frame within a range not exceeding a marginal capacity of a buffer for reception, in the case of a still image, the whole image quality of the GOP is improved.

The codec CPU 122 that functions as a processing control unit in FIG. 3 can output type information TI, parameter information PI, and current frame FI to the engine block 126. The code CPU 122 can check whether the code memory 128 is saturated and can generate a check signal BF corresponding to a check result. The codec CPU 122 can receive an encoding finishing signal DI with respect to the current frame FI output from the engine block 126 to transmit the encoding finishing signal DI to the pre-processing circuit 110.

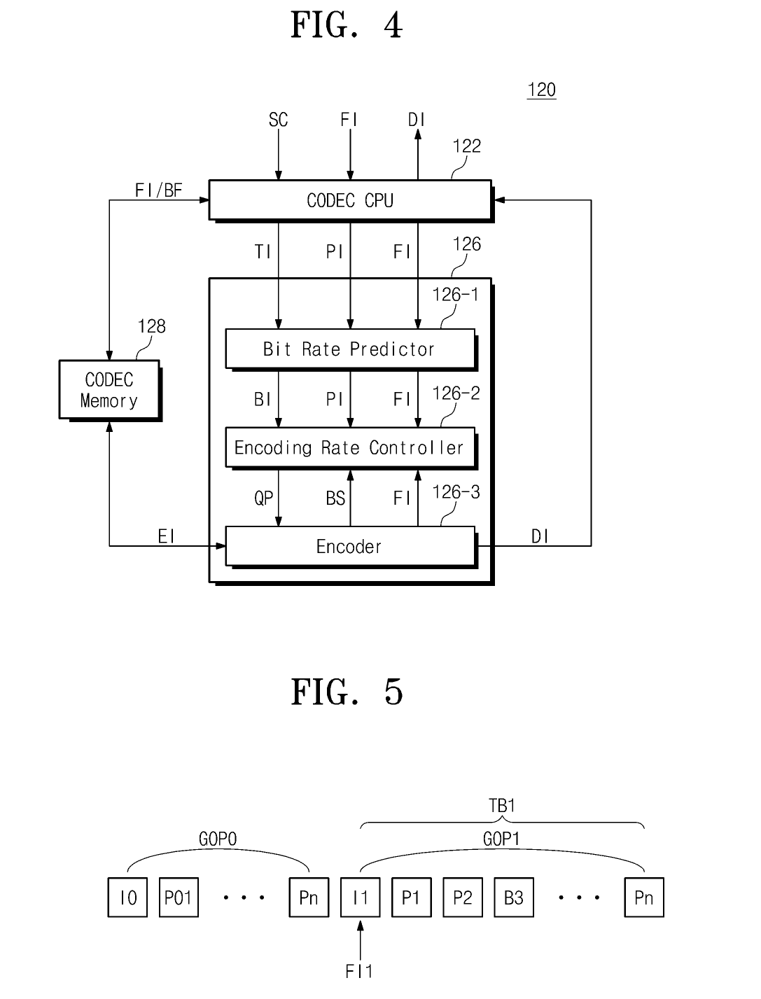

The engine block 126 can receive the type information TI and the parameter information PI transmitted from the codec CPU 122. The engine block 126 can be configured as illustrated in FIG. 4 to perform a bit rate prediction, an encoding rate control, and an encoding with respect to a current window. The engine block 126 can transmit an encoded current frame EI to the codec memory 128. If an encoding with respect to a current frame FI is finished, the engine block 126 can transmit an encoding finishing signal DI to the codec CPU 122.

The codec memory 128 can receive the encoded current frame EI being output from the engine block 126 to store it. The codec memory 128 may include a plurality of buffers and/or a plurality of virtual buffers. The codec memory 128 may be embodied by a volatile memory or a nonvolatile memory.

FIG. 4 is a detailed block diagram of the codec illustrated in FIG. 3.

Referring to FIG. 4, the engine block 126 may include a bit rate predictor 126-1, an encoding rate controller 126-2, and an encoder 126-3.

The bit rate predictor 126-1 can predictively allocate all of the target number of bits with respect to a current window and a target number of bits of an intra frame. In this case, the type information TI and the parameter information PI transmitted from the codec CPU 122 may be referred to an allocation of an initial target number of bits with respect to a current intra frame FI. The initial target number of bits may mean the number of bits (or bit capacity) which the bit rate predictor 126-1 primarily allocates to encode a current frame FI.

The bit rate predictor 126-1 can allocate all of the target number of bits with respect to a GOP including a current frame FI and can allocate a target number of bits with respect to each of frames included in the GOP using type information TI and parameter information PI of the current frame FI. The bit rate predictor 126-1 can transmit bit information BI including the target number of bits with respect to the current frame FI to the encoding rate controller 126-2. The bit information BI may include the target number of bits with respect to the current frame FI and may include all of the target number of bits allocated with respect to a current window including the current frame FI. The bit information BI may include a target number of bits with respect to each of frames included in the current window. The bit rate predictor 126-1 may be embodied in hardware or software.

The encoding rate controller 126-2 generates a quantization parameter with respect to each block of the frames inside the current window. In the case that a skip mode occurrence frequency calculated by the processing control unit 122 exceeds the reference value, an allocation number of bits with respect to an intra frame of the current frame FI inside the current window is allocated to be higher than an initial target number of bits of the intra frame. Thus, in an encoding operation, a quantization parameter may be set to an initial value or may be set lower than a quantization parameter set in the case of a non-still image. That is, image quality of an I-frame which is the first frame among the frames included in the GOP forms a large part of the whole image quality of the GOP. Thus, in an encoding operation, a quantization parameter QP is controlled low. A quantizer performing a quantization according to the quantization parameter QP may be included inside the encoder 126-3. An allocation number of bits with respect to an intra frame can be allocated to be higher than a target number of bits of the intra frame by controlling other parameters without a control of the quantization parameter QP.

The encoding rate controller 126-2 can determine a relatively low quantization parameter QP by a block when an allocation number of bits with respect to an intra frame of the current frame FI of the current window is allocated to be higher than an initial target number of bits of the intra frame. In the case that a block skip occurs many times like for a still image, image quality of an I-frame which is the first frame among the frames included in the GOP forms a large part of the whole image quality of the GOP. Thus, if relatively many bits are allocated to the I-frame, in the case that a block skip occurs, relatively high image quality can be maintained. When processing a still image that occurs in an image conversion, skip mode information that occurs in a P-frame or a B-frame may be provided from an entropy coding block or the encoder 126-3. The encoder 126-3 can encode a current frame FI by a block unit using a quantization parameter QP. The encoder 126-3 can encode a current frame FI by a block unit using a quantization parameter (QP=QP1′−QP16′) controlled in the case that a skip mode occurrence frequency exceeds a reference value.

The encoder 126-3 can encode a current frame FI by a block unit using different quantization parameters (QP=QP1−QP16, QP=QP1′−QP16′) with respect to the case that a skip mode occurrence frequency exceeds a reference value and the case that a skip mode occurrence frequency does not exceed a reference value respectively. The encoder 126-3, if an encoding with respect to the current frame FI is completed, can transmit an encoding completion signal DI to the codec CPU 122. The encoding completion signal DI may include information about the number of bits used while the current frame FI is encoded by the encoder 126-3. The encoder 126-3, if an encoding with respect to the current frame FI is completed, can provide an encoded current frame EI to the codec memory 128.

FIG. 5 is a drawing explaining a target number of bits allocation method of a codec according to FIG. 4.

FIG. 5 is a block diagram for explaining a method in which the bit rate predictor 126-1 of FIG. 4 allocates all of the target number of bits with respect to a GOP (group of picture) and a target number of bits with respect to frames in the case that a current frame is an I-frame.

In FIG. 5, a GOP0 represents a previous window comprised of n number of frames and a GOP1 represents a current window comprised of n number of frames. Herein, n is a natural number which is 2 or more. FIG. 5 illustrates an encoding order as an illustration.

Referring to FIGS. 4 and 5, when type information TI of a current frame (FI=FI1=I1) represents an I-frame, the bit rate predictor 126-1 can allocate all of the target number of bits TB1 with respect to a current window. That is, the bit rate predictor 126-1 can allocate all of the target number of bits TB1 with respect to all frames inside the current window including an I-frame (I1), P frames (P1˜PN, N is a natural number which is 2 or more) and a B-frame (B3). The bit rate predictor 126-1 can calculate the number of target number of bits (TB1) with respect to the GOP1 using a mathematical formula 1.

TB=K*br/f [Mathematical Formula 1]

Herein, TB represents the number of target number of bits (TB1) of the GOP1 including the current frame (FI), K represents a size of the GOP1, br represents a bit-rate of the current frame (FI), and the f represents a frame-rate or a picture-rate.

For instance, if the bit-rate (br) is 300, the size (K) of the GOP1 is 30 and the frame-rate (f) is 30, the entire number of target number of bits (TB) becomes 300. If the bit-rate (br) is 300, the size (K) of the GOP1 is 300 and the frame-rate (f) is 30, the entire number of target number of bits (TB) becomes 3000.

The bit rate predictor 126-1 can allocate a target number of bits with respect to the current frame (FI or FI1) using all of the target number of bits (TB1) with respect to the predicted GOP1. For instance, the bit rate predictor 126-1 can allocate (or calculate) a target number of bits (T) with respect to the current frame (FI or FI1) using a mathematical formula 2.

T=(xL/kL)/(xi/ki+Np*xp/kp+Nb*xb/kb)*R [mathematical formula 2]

Herein, xL means a complexity of an Lth (L is a natural number) frame, xi means a complexity of an i-frame, xp means a complexity of a p-frame, xb means a complexity of a b-frame, kL means a normalization constant of an Lth frame, ki means a normalization constant (ki=1111) of an i-frame, kp means a normalization constant (kp=1) of a p-frame, kb means a normalization constant (kb=1,4) of a b-frame, Np means the number of p-frames that are not processed in a GOP, Nb means the number of b-frames that are not processed in the GOP, and R means the number of bits that are not used while encoding the GOP.

The bit rate predictor 126-1 can allocate a target number of bits with respect to a current frame (FI, FI2 or P2) based on the number (D) of frames that are included in the GOP1 and not processed.

For instance, if the current frame (FI, FI2 or P2) is a P-frame, and the number of the P-frames is 29, the number (D) of frames that are not processed becomes 28. The bit rate predictor 126-1 can calculate a target number of bits with respect to the current frame (FI, FI2 or P2) using a mathematical formula 3, which is described subsequently.

The bit rate predictor 126-1 can transmit bit information (BI) including the target number of bits with respect to the current frame (FI) to the encoding rate controller 126-2.

The bit information (BI) may include the target number of bits with respect to the current frame (FI) and all of the target number of bits allocated with respect to the GOP1 including the current frame (FI). The bit information (BI) may include a target number of bits with respect to each of frames included in the GOP1.

Once the bit information (BI) is determined, a proper quantization parameter (QP) is determined according to the bit information (BI). If in the case that a skip mode occurrence frequency exceeds a reference value, a lot of target bits are finally determined, and relatively a large amount of bits occurs with respect to the intra frame inside the current window.

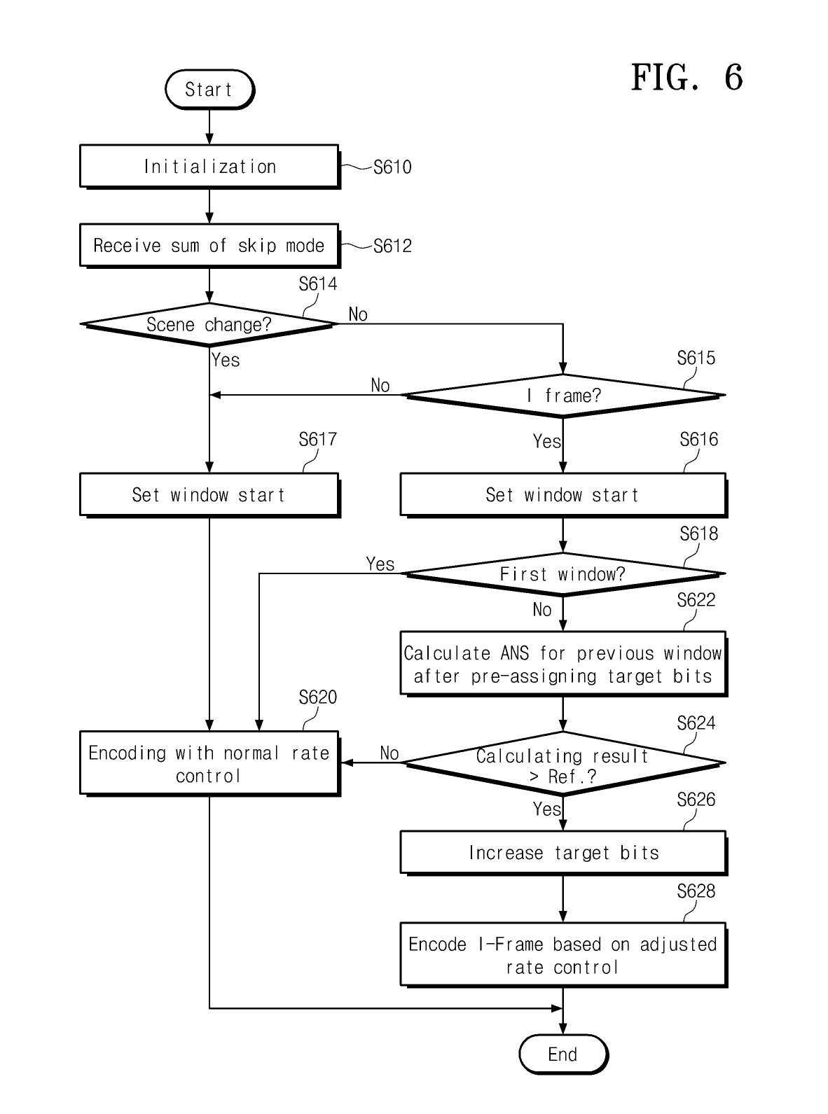

FIG. 6 is a flow chart of rate control encoding using skip mode information in accordance with exemplary embodiments of the disclosure.

FIG. 6 includes steps S610˜S628 and may be executed by the codec 120 of FIG. 3 or FIG. 4. Each step will be described later.

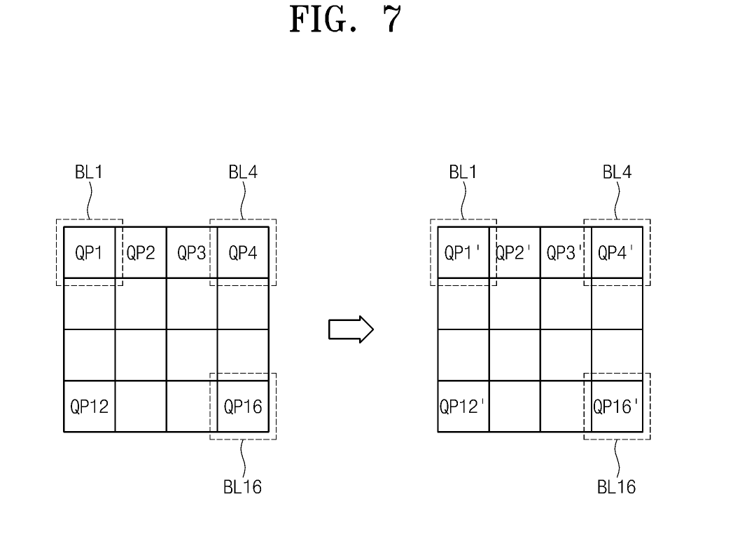

FIG. 7 is a drawing explaining a quantization parameter control of a codec according to FIG. 4.

Referring to FIG. 7, the encoding rate controller 126-2 can generate a quantization parameter (e.g., QP1 or QP1′) with respect to each of blocks included in a current frame (FI). It is assumed that the current frame (FI), in particular, an intra frame includes 4*4 blocks. The number of blocks with respect to the current frame (FI) is only illustrative and the disclosure is not limited thereto. The current frame (FI) may include 16 blocks BL1˜BL16 and the encoding rate controller 126-2 can generate quantization parameters QP1˜QP16 with respect to the blocks BL1˜BL16.

The encoding rate controller 126-2 can generate the quantization parameter QP1 with respect to the first block BL1. If another target number of bits is allocated from the bit rate predictor 126-1, the encoding rate controller 126-2 can generate another quantization parameter QP1′ with respect to the first block BL1. The encoding rate controller 126-2 can transmit a quantization parameter (QP=QP1-QP16′) controlled with respect to each of blocks included in the current frame (FI) to the encoder 126-3.

The encoding rate controller 126-2 can calculate a quantization parameter (QP) with respect to each block using a mathematical formula 3.

QP=(k2/31)*dn/r_seq [mathematical formula 3]

Herein, QP means a quantization parameter, k2 means a first constant, r_seq means a second constant, and do means a buffer saturation. The encoding rate controller 126-2 can control rate control parameters of the current frame (FI) based on parameter information (PI). The encoding rate controller 126-2 can generate a quantization parameter (QP) with respect to each of blocks included in the current frame (FI) using a target number of bits and a rate control parameter with respect to each of frames allocated by the bit rate predictor 126-1.

The codec CPU 122 determines a type of the current frame (FI) and can generate type information (TI) based on the determined type of the current frame (FI). The codec CPU 122 determines rate control parameters of the current frame (FI) and can generate parameter information (PI) using the determined rate control parameters.

The rate control parameter may mean parameters that can control a bit-rate of the current frame (FI). Firmware 124 being executed in the codec CPU 122 determines whether the current frame (FI) is an I-frame, a P-frame or a B-frame according to a characteristic of the GOP and can generate type information (TI) according to a determination result. The firmware 124 being executed in the codec CPU 122 determines the rate control parameters of the current frame (FI) and can generate parameter information (PI) according to a determination result.

The rate control parameters of the current frame (FI) may include a complexity according to a type of each of frames, a size (e.g., all of the target number of bits with respect to the GOP) of the GOP, the number of frames per second (or pictures per second) corresponding to a frame-rate, the number of bits per second corresponding to a bit rate, a normalization constant and an initial buffer saturation (d0).

The codec CPU 122 can calculate complexity of the current frame (FI) at every GOP.

The codec CPU 122 can calculate complexity (xi, xp, or xb) of the current frame (FI) using a mathematical formula 4.

xi=160*(br)/115,xp=60*(br)/115,xb=42*(br)/115 [mathematical formula 4]

Herein, the xi is complexity when the current frame (FI) is an I-frame, the xp is complexity when the current frame (FI) is a P-frame, and the xb is complexity when the current frame (FI) is a B-frame. Parameter br may mean a bit-rate or the number of bits per second of the current frame (FI). The codec CPU 122 can determine a bit-rate (br) and can determine a complexity (xi) of the I-frame, complexity (xp) of the P-frame and/or complexity (xb) of the B-frame using the determined bit-rate.

For instance, if the bit-rate is 115, xi is 160, xp is 60 and xb is 42.

The parameter information (PI) may include the rate control parameters of the current frame (FI). The parameter information (PI) may include the complexity (xi, xp, or xb) of the current frame (FI), a size of GOP, the number of bits per second, and/or the number of frames per second.

The mathematical formulas 1˜4 described above are applied to a specific model only in favor of a rate control as an illustration and the disclosure is not limited thereto and a rate control of various ways is possible.

The codec CPU 122 can check whether the codec memory 128 is saturated or not and can generate a check signal (BF). The codec CPU 122 compares the number of bits of encoded frames stored in the codec memory 128 with all of the target number of bits that can be stored in a memory space of the codec memory 128 allocated to a GOP and can check whether the codec memory 128 is saturated or not according to a comparison result.

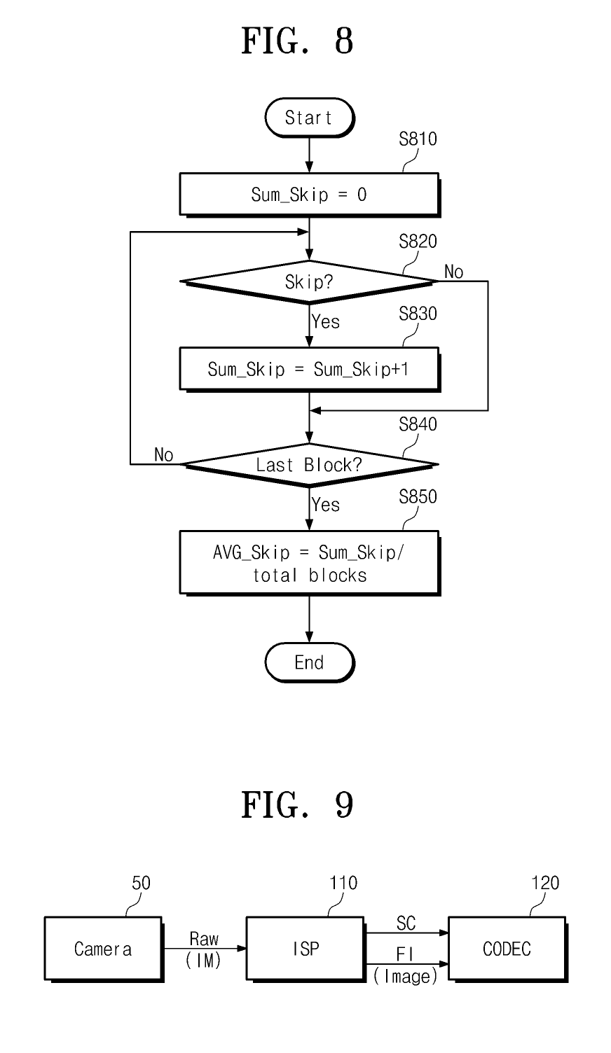

FIG. 8 is a flow chart of a skip mode occurrence check according to FIG. 6.

The encoder 126-3 performing an entropy coding performs an operation according to FIG. 8 to generate skip mode information. The skip mode information may be the average number of skips per block inside the frame. The skip mode information may be provided to the codec CPU 122 to execute a step S612 of FIG. 6.

That is, in FIG. 6, after performing an initialization of the step S610, the codec CPU 122 can receive the skip mode information from the encoder 126-3 as the sum of skip mode.

In a step S810 of FIG. 8, the number (SUM_SKIP) of skips is initially set to 0 in a storage unit like a register and in a step S820, it is checked whether a skip of a block occurs. In the case that a skip of a block occurs, the number (SUM_SKIP) of skips increases by 1 through a step S830. The increasing counting is performed over all the blocks of one frame. In a step S840, if the increasing counting is performed until the last block of one frame, in a step S850, the number of totally counted skips divided by the entire number of blocks inside the frame gives the average number of skips per block.

Referring to FIG. 6 again, the codec CPU 122 can check whether scene change information SC is received in a step S614. The scene change information SC may be provided from the pre-processing circuit (ISP: 110) of FIG. 1 or 9. The pre-processing circuit 110 embodied by ISP detects whether a scene change of a frame being applied occurs and generates scene change information according to a detection result. The scene change information may be set by a flag. In the case that a scene change occurs, the pre-processing circuit 110 can generate a flag representing ‘1’ and in the case that a scene change does not occur, the pre-processing circuit 110 can generate a flag representing ‘0’.

FIG. 9 is a block diagram suggested to explain a path of screen change information according to FIG. 6. Referring to FIG. 9, a raw image is generated from a camera 50, which is a video source, to be provided as first data IM. An ISP 110 detects whether a scene change of a frame being applied occurs and generates scene change information (SC). The scene change information (SC) may be provided to the codec 120. The ISP 110 can output second data FI generated according to a pre-processing result to the codec 120.

In the case of receiving scene change information (SC) indicating a scene change, the codec CPU 122 sets a window start in a step S617. After an execution of the step S617, a rate control is performed by the set data control, which is previously set (step S620).

In the case that a scene change does not occur, in a step S615, it is checked whether a frame is an I-frame. If the frame is an I-frame, in the step S616, a window start is set. In a step S618, it is checked whether a window is the first window. If the window is the first window, a rate control is performed by the rate control previously set (step S620). That is, since in the case of the first GOP, since a previous window does not exist, the rate control is performed by a normal control and then an encoding is executed. In this case, in the normal control, a bit with respect to a corresponding frame may be allocated at a target number of bits rate initially set by the bit rate predictor 126-1.

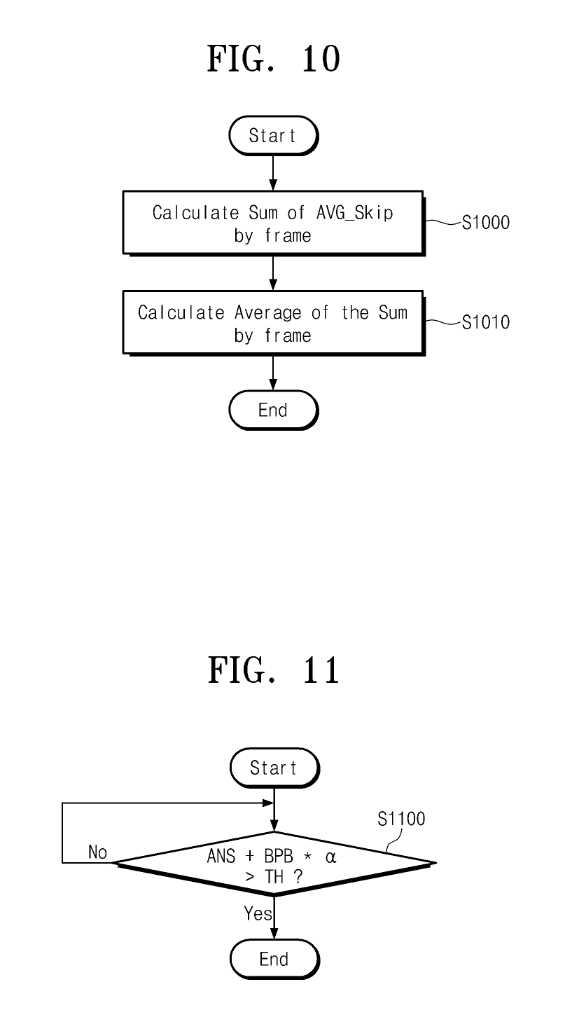

In the case that the window is not the first window, for example, the window is a second window, a step S622 is executed as illustrated in FIG. 10.

FIG. 10 is a flow chart of a skip mode occurrence frequency calculation by frames according to FIG. 6.

Referring to FIG. 10, a sum is calculated for a number of frames using an average number of skips per block with respect to frames of a previous window (step S1000) and an average of the sum per unit frame is calculated (step S1010).

In the step S622, an average number (ANS) of skip modes with respect to the previous window is obtained. The ANS may be called a skip mode occurrence frequency. The skip mode occurrence frequency may be obtained after a target number of bits with respect to an intra frame of a current window is predictably allocated in advance.

If the skip mode occurrence frequency is obtained, a step S624 of FIG. 6 may be executed. The step S624 of FIG. 6 may be performed by the codec CPU 122. The step S624 of FIG. 6 is a step of comparing the calculated skip mode occurrence frequency with a reference value and may be executed according to FIG. 11.

FIG. 11 is a flow chart illustrating a comparison between the skip mode occurrence frequency calculation according to FIG. 6 and a reference value.

Referring to FIG. 11, it is checked whether ANS+BPB*α is greater than a threshold value TH (S1100). Here, BPB indicates the number of bits per block and α is a scaling vector.

In the case that the skip mode occurrence frequency exceeds the reference value, it is controlled that an allocation number of bits with respect to the intra frame inside the current window is allocated to be higher than a target number of bits initially set for the intra frame.

In the case that the skip mode occurrence frequency exceeds the reference value, the bit rate predictor 126-1 increases an allocation number of bits with respect to the intra frame inside the current window. Thus, the substantial allocation number of bits with respect to the intra frame inside the current window is allocated to be higher than the target number of bits initially set of the intra frame (S626).

In a step S628, the encoder 126-3 can encode a first intra frame of the current window by a block unit by adjusting a quantization parameter (QP) according to a given target number of bits.

The encoder 126-3, if an encoding with respect to the current frame (FI) is completed, can transmit an encoding completion signal (DI) to the codec CPU 122. The encoding completion signal (DI) may include information about the number of bits used while the current frame (FI) is encoded by the encoder 126-3. The encoder 126-3, if an encoding with respect to the current frame (FI) is completed, can transmit an encoded current frame (EI) to the codec memory 128.

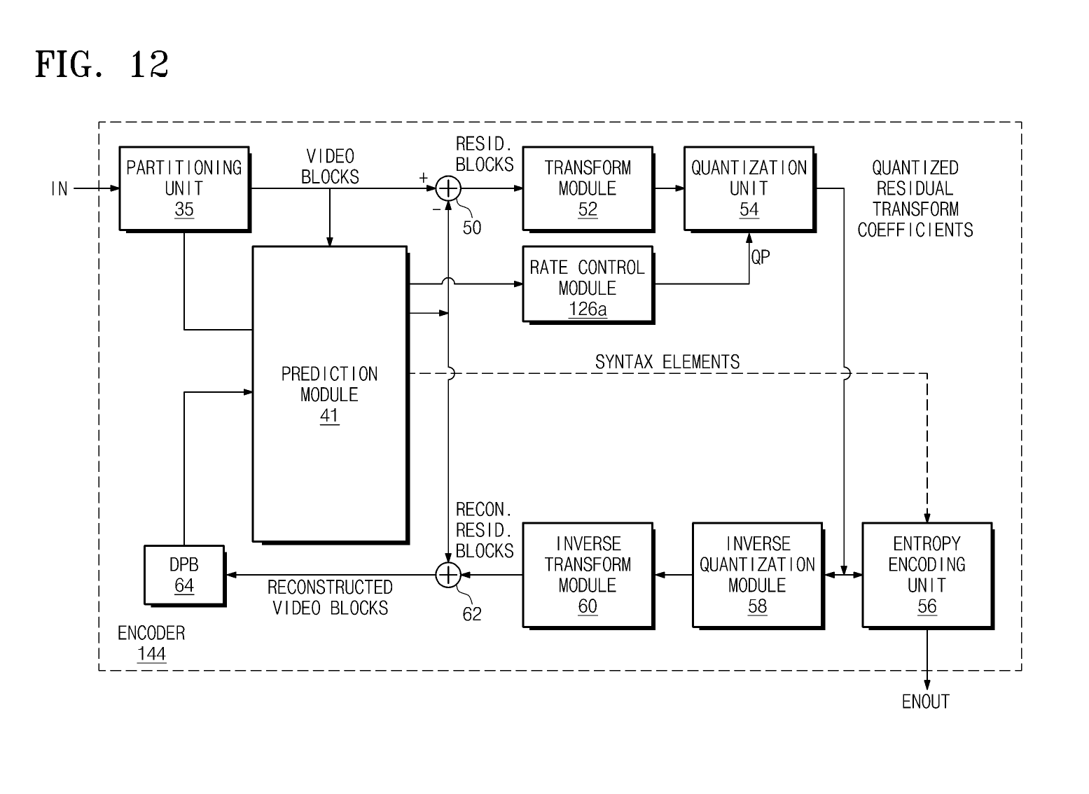

FIG. 12 is a block diagram of an encoder according to FIG. 2.

Referring to FIG. 12, an encoder 144 can perform an intra coding and an inter coding inside video pictures.

The intra coding depends on a spatial prediction to reduce or remove a spatial redundancy in a video inside a predetermined video picture. The inter coding depends on a temporal prediction to reduce or remove a temporal redundancy in a video inside adjacent pictures of a video sequence. An intra mode (I mode) may refer to a random one among compression modes based on various spaces. Inter modes like a unidirectional prediction (P mode) and a bidirectional prediction (B mode) may refer to a random one among compression modes based on various spaces.

The encoder 144 may include a partitioning unit 35, a prediction module 41, a decoding picture buffer (DPB) 64, a summer 50, a transform module 52, a quantization unit 54, an entropy encoding unit 56, and a rate control unit 126a.

The prediction module 41 may include a motion estimation unit, a motion compensation unit and an intra prediction unit.

To reconstruct a video block, the encoder 144 may include an inverse quantization module 58, an inverse transform module 60, and a summer 62. To remove blocking artifacts in the reconstructed video, a deblocking filter that filters block boundaries may be additionally included. The deblocking filter may be connected to an output stage of the summer 62.

As illustrated in FIG. 12, the encoder 144 can receive current video blocks IN inside an encoded slice or a video picture. A picture or a slice may be divided into a plurality of video blocks or CUs but may also include PUs and TUs.

One of a plurality of coding modes, for instance, an intra or inter mode may be selected with respect to a current video block based on error results.

The prediction module 41 provides an intra-coded block or an inter-coded block to the summer 50 to generate residual block data. The prediction module 41 provides an intra-coded block or an inter-coded block to the summer 62 to reconstruct an encoded block for use as a reference picture.

The intra prediction unit inside the prediction module 41 can perform an intra prediction coding of a current video block with respect to one or more adjacent blocks in a picture or a slice which is the same as a current block to be coded to provide a spatial compression.

The motion estimation unit and the motion compensation unit perform an inter prediction coding of the current video block with respect to one or more prediction blocks in one or more reference pictures to provide a temporal compression.

The motion estimation unit and the motion compensation unit may be integrated into one chip but for convenience of description, they are separated from each other.

A motion estimation performed by the motion estimation unit is a process of generating motion vectors. The motion vectors estimate a motion with respect to video blocks. The motion vectors may represent a displacement of a video block inside a current video picture with respect to a prediction block inside the reference picture.

The prediction block is a block that closely coincides with a video block to be coded from a pixel difference point of view. The pixel difference may be determined by a sum of absolute difference (SAD), a sum of square difference (SSD), or other difference matrixes.

The encoder 144 can calculate values with respect to sub-integer pixel positions of reference pictures stored in the DPB 64. For example, the encoder 144 can calculate values of ¼ pixel positions, ⅛ pixel positions or different fractional pixel positions of the reference picture. Thus, the motion estimation unit performs a motion search with respect to full pixel positions and fractional pixel positions and outputs a motion vector having a fractional pixel precision.

The motion estimation unit can transmit the calculated motion vector to the entropy encoding unit 56 and the motion compensation unit. A motion compensation performed by the motion compensation unit may accompany a fetch or generation of a prediction block based on a motion vector determined by the motion estimation.

If receiving a motion vector with respect to a current video block, the motion compensation unit may find a prediction block which the motion vector indicates.

The encoder 144 can form a residual video block forming pixel difference values by subtracting a pixel value of the prediction block from pixel values of the current video block. The pixel difference values may form residual data with respect to a block and may include both a luminance difference component and a chromaticity difference component.

After the motion compensation unit generates the prediction block with respect to the current video block, the encoder 144 forms a residual video block by subtracting the prediction block from the current video block. The transform block 52 may form one or more transform units (TU) from a residual block. The transform block 52 generates a video block including residual transform coefficients by applying a discrete cosine transform (DCT) or a conceptually similar transform to the TU. The residual block may be transformed into a transform domain like a frequency domain in a pixel domain by the transform operation.

The transform module 52 can transmit generated transform coefficients to the quantization unit 54. The quantization unit 54 can quantize transform coefficients to further reduce a bit rate. A quantization process can reduce a bit depth associated with some or all coefficients. The degree of quantization may be modified by adjusting a quantization parameter (QP). The quantization unit 54 may perform a scan of a matrix including quantized transform coefficients.

The rate control module 126a may adjust the quantization parameter (QP) according to skip mode information.

After a quantization, the entropy encoding unit 56 entropy-codes the quantized transform coefficients. For example, the entropy encoding unit 56 can perform a context adaptive variable length coding (CAVLC), a context adaptive binary arithmetic coding (CABAC), a probability interval partitioning entropy (PIPE), or other entropy encoding technology. Subsequent to entropy encoding by the entropy encoding unit 56, an encoded bit stream ENOUT may be transmitted to a decoder 146 or may be archived for a later transmission or output.

The inverse quantization module 58 and the inverse transform module 60 reconstruct a residual block of the pixel domain as a reference block of a reference picture for use later by applying an inverse quantization and an inverse transform. The motion compensation unit can calculate a reference block by adding the residual block to one prediction block of the reference pictures. The motion compensation unit may also apply at least one interpolation filter to the reconstructed residual block to calculate sub-integer pixel values for use in the motion estimation.

The summer 62 generates a reference picture list for adding the reconstructed residual block to a motion compensated prediction block generated by the motion compensation unit to store the added block in the DPB 64. The reference picture list becomes a reference block for inter-predicting a block in a subsequent video picture.

The encoding method according to FIG. 12 may be one of HEVC, VP8, VP9, MPEG-2, MPEG-4, H.263, and H.264.

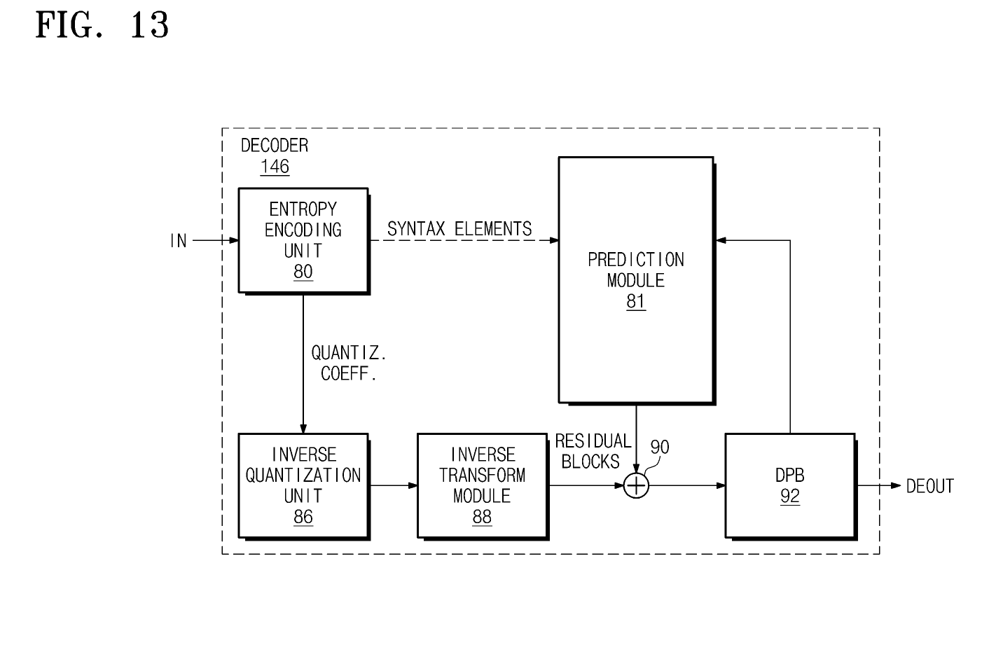

FIG. 13 is a block diagram of a decoder according to FIG. 2.

In FIG. 13, a decoder 146 may include an entropy decoding unit 80, a prediction module 81, an inverse quantization unit 86, an inverse transform unit 88, a summer 90, and a decoding picture buffer (DPB) 92.

The prediction module 81 may include a motion compensation unit and an inter prediction unit like FIG. 12. The decoder 146 may perform a decoding process which is an inverse order of the encoding process described for the encoder 144.

During the decoding process, the decoder 146 can receive construction elements representing encoding information and an encoded video bit stream including an encoding video block from the encoder 144.

The entropy decoding unit 80 of the decoder 146 entropy-decodes a bit stream to generate quantized coefficients, motion vectors, and other prediction constructions. The entropy decoding unit 80 transmits the motion vectors and other prediction constructions to the prediction module 81.

The decoder 146 may receive construction elements from a video prediction unit level, a video coding level, a video slice level, a video picture level, and/or a video sequence level.

If the video slice is coded as an intra coded slice, an intra prediction unit of the prediction module 81 can generate prediction data with respect to a video block of a current video picture based on data from blocks decoded before a current picture and a signaled intra prediction mode. If the video block is inter-predicted, the motion compensation of the prediction module 81 generates prediction blocks with respect to a video block of a current video picture based on a prediction construction and a motion vector received from the entropy decoding unit 80 or vectors.

A motion compensation unit of the prediction module 81 determines prediction information with respect to a current video block by parsing motion vectors and prediction constructions and generates prediction blocks with respect to the current video block being decoded using the prediction information.

The inverse quantization unit 86 inverse-quantizes, that is, dequantizes quantized transform coefficients provided from a bit stream and decoded by the entropy decoding unit 80. An inverse quantization process may include use of a quantization parameter calculated by the encoder 144 with respect to a CU or a video block to determine the degree of quantization and the degree of inverse quantization that has to be applied.

To generate residual blocks in a pixel domain, the inverse transform module 88 applies an inverse transform, for instance, an inverse DCT, an inverse integer transform, or a conceptually similar inverse transform process with respect to transform coefficients.

After the motion compensation unit generates a prediction block with respect to the current video block based on the motion vectors and the prediction construction elements, the decoder 146 forms a decoded video block by adding residual blocks from the inverse transform module 88 to corresponding prediction blocks generated by the motion compensation unit.

The summer 90 represents a component or components that perform the add operation. If preferred, a deblocking filter that filters decoded blocks may also be applied to remove blocking artifacts. And then, decoded video blocks are stored in the DPB 92 and this provides a standard block of reference pictures with respect to subsequent motion compensation. The DPB 92 also generates decoded video to display an image on a display device.

The firmware 124 of FIG. 3 can be embodied in a general-purpose digital computer that operates the program using a program writable and computer readable recording medium. The computer readable recording medium may include a storage medium such as a magnetic storage medium (e.g., a ROM, a floppy disk, a hard disk, etc.), an optical readable medium (e.g., a CD ROM, a DVD, etc.), or an SSD.

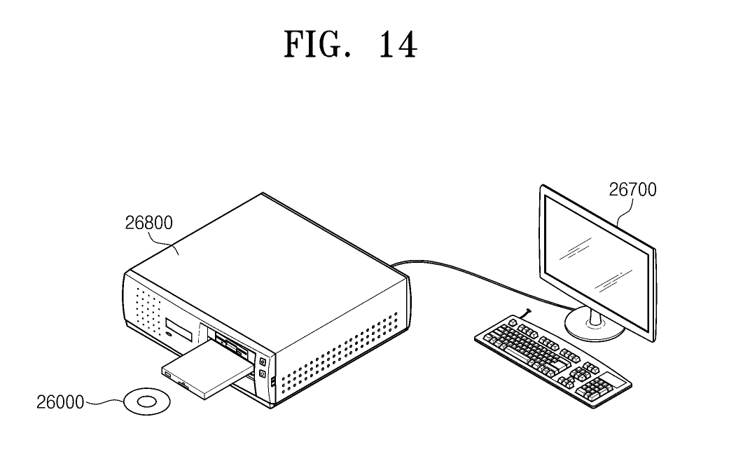

FIG. 14 is a drawing illustrating an application example applied to a disk driver connected to a computer system.

FIG. 14 illustrates a disk drive 26800 for recording and reading out a program using a disk 26000 or a semiconductor memory. The computer system 26700 can store a program for embodying a video encoding method of the disclosure using a disk drive 26800 or a semiconductor memory.

To execute a program in the disk 26000 or the semiconductor memory on the computer system 26700, a program from the disk 26000 or the semiconductor memory is read out by the disk drive 26800 and the program may be transmitted to the computer system 26700.

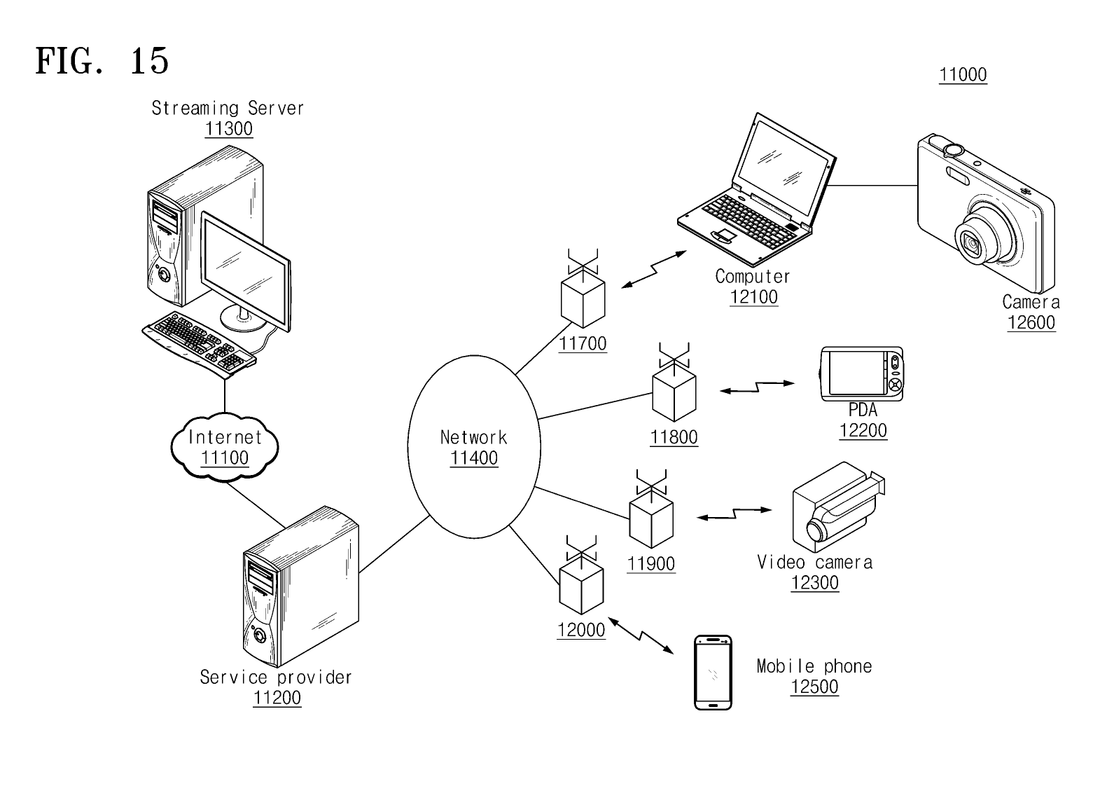

A system to which the video encoding method according to FIG. 14 is applied is illustrated in FIG. 15.

FIG. 15 is a drawing illustrating an application example of the disclosure applied to a content supply system.

FIG. 15 illustrates the entire structure of a content supply system 11000 for providing a content distribution service.

A service area of a communication system is divided into cells having a predetermined size and wireless base stations 11700, 11800, 11900 and 12000 may be installed in each cell.

The content supply system 11000 includes a plurality of independent devices. For example, independent devices such as a computer 12100, a PDA (personal digital assistant) 12200, a video camera 12300, and a mobile phone 12500 may be connected to an internet 11100 by way of an internet service suppler 11200, a communication network 11400, and the wireless base stations 11700, 11800, 11900 and 12000.

However, the content supply system 11000 is not limited to the structure illustrated in FIG. 15 and devices may be selectively connected to one another. The independent devices may be directly connected to the communication network 11400 without passing through the wireless base stations 11700, 11800, 11900 and 12000.

The video camera 12300 is an image pickup device capable of shooting a video image like a digital video camera. A mobile phone 12500 can adopt at least one communication method among various protocols such as a PDC (personal digital communication), a CDMA (code system multiple access), a W-CDMA (wideband CDMA), a GSM (global system for mobile communication), and a PHS (personal handyphone system).

The video camera 12300 may be connected to a streaming server 11300 by way of the wireless base station 11900 and the communication network 11400.

The streaming server 11300 can streaming transmit content transmitted by a user using the video camera 12300 in real-time broadcasting. Content received from the video camera 12300 may be encoded by the video camera 12300 or the streaming server 11300. Video data shot by the video camera 12300 may be transmitted to the streaming server 11300 by way of the computer 12100.

Video data shot by a camera 12600 may also be transmitted to the streaming server 11300 by way of the computer 12100. The camera 12600 is an image pickup device that can shoot both a still image and a video image like a digital camera. Video data received from the camera 12600 may be encoded by the camera 12600 or the computer 12100. Software for video encoding and video decoding may be stored in a computer readable recording medium like a compact disk read-only memory (CD ROM), a floppy disk, a hard disk drive, a solid stated drive (SSD), and a memory card which the computer 12100 can access.

In the case that video is shot by a camera loaded into the mobile phone 12500, video data can be received from the mobile phone 12500.

The video data may be encoded by a LSI (large scale integrated circuit) system loaded into the video camera 12300, the mobile phone 12500, or the camera 12600.

In the content supply system 11000, a content recorded by a user using the video camera 12300, the camera 12600, the mobile phone 12500 or other image pickup device is encoded and then is transmitted to the streaming server 11300. The streaming server 11300 can stream transmit content data to other clients which requested content data.

Clients may be a device that can decode encoded content data, for example, the computer 12100, the PDA 12200, the video camera 12300, or the mobile phone 12500. Thus, the content supply system 11000 makes the clients receive and recycle encoded content data. The content supply system 11000 makes the clients receive encoded content data, and decode and recycle the received encoded content data in real time, and thereby a personal broadcasting becomes possible.

The encoder and the decoder in accordance with example embodiments of the disclosure may be applied to an encoding operation and a decoding operation of the independent devices included in the content supply system 11000. Thus, in the case of a still image, the whole image quality of a picture group being encoded is improved and thereby operation performance of the content supply system 11000 is improved.

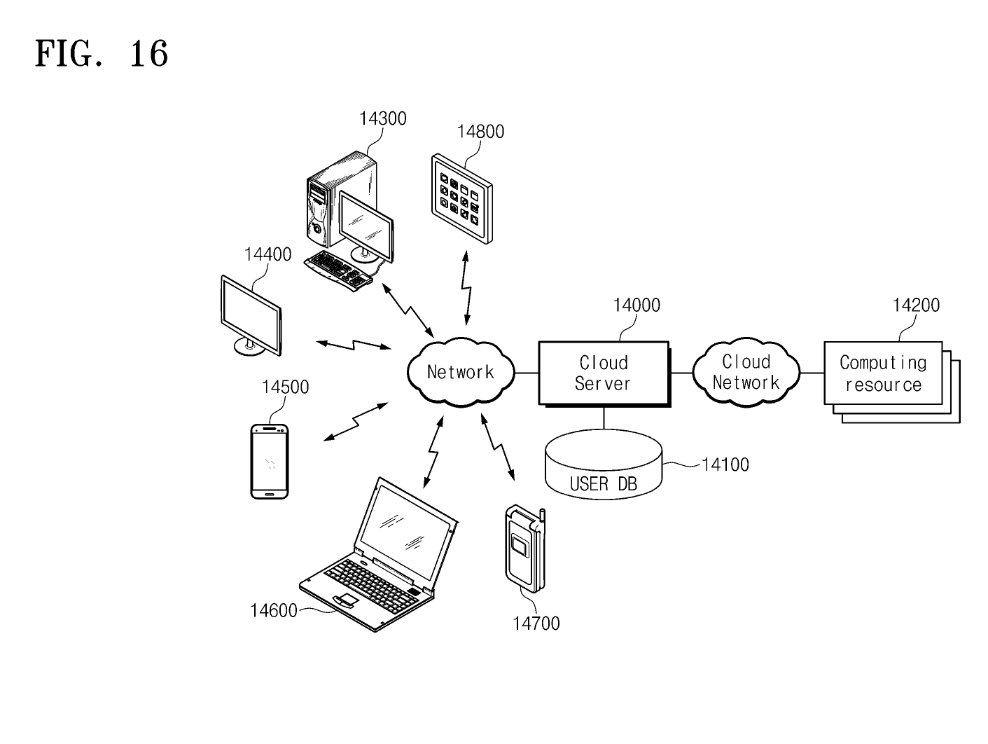

FIG. 16 is a drawing illustrating an application example of the disclosure applied to a cloud computing system using an encoder and a decoder.

Referring to FIG. 16, a network structure of the cloud computing system using an encoder and a decoder is illustrated as an illustration.

The cloud computing system of the disclosure consists of a cloud computing server 14000, a user DB 14100, a computing resource 14200, and user terminals.

The user terminal may be provided as one of various constituent elements of an electronic device.

The cloud computing system provides an on-demand outsourcing service of the computing resource through an information communication network like an internet according to a request of a user terminal. In a cloud computing environment, a service provider integrates computing resources of a data center that exist at different physical locations using a virtual technology to provide a service that users need.

A service user does not install a computing resource such as an application, storage, an operating system (OS), a security at each terminal of user to use it but can use a service in a virtual space generated through a virtual technology as much as wanted when necessary.

A user terminal of a specific service user connects to a cloud computing server 14000 through an information communication network including an internet and a mobile communication network. User terminals can be provided with a cloud computing service, in particular, a video play service. The user terminal may be all electronic devices capable of internet connection such as a desktop PC 14300, a smart TV 14400, a smart phone 14500, a notebook 14600, a PMP (portable multimedia player) 14700, a tablet PC 14800, etc.

The cloud computing server 14000 can integrate multiple computing resources 14200 distributed in a cloud network to provide them to the user terminal. The multiple computing resources 14200 may include several data services and may include data uploaded from the user terminal. The cloud computing server 14000 integrates video data bases distributed in several places using a virtualization technology to provide a service which the user terminal wants.

User information of users subscribed to a cloud computing service is stored in a user DB 14100. The user information may include personal credit information such as login information, an address, a name, etc. The user information may include an index of videos. The index may include a list of videos of which a playback is completed, a list of videos that is being played and a stop time of a video that is being played.

User devices may share information about a video stored in the user DB 14100. Thus, in the case that a predetermined video service is provided to the notebook 14600 according to a playback request from the notebook 14600, a playback history of the predetermined video service is stored in the user DB 14100. In the case that a playback request of a video service is received from the smart phone 14500, the cloud computing server 14000 searches a predetermined video service to play it with reference to the user DB 14100.

In the case that the smart phone 14500 receives a video data stream through the cloud computing server 14000, an operation of decoding the video data stream to play a video is similar to an operation of the mobile phone 12500.

The cloud computing server 14000 may refer to a playback history of the predetermined video service stored in the user DB 14100. The user terminal may include the aforementioned decoder of the disclosure. In another example, the user terminal may include the aforementioned encoder of the disclosure. The user terminal may also include the aforementioned codec of the disclosure. Thus, image quality performance of the cloud computing system is improved.

Examples to which the aforementioned video encoding method is applied were described in FIG. 16. However, a variety of embodiments in which the video encoding method described above is stored in a storage medium or a codec is embodied in a device are not limited to the embodiments described with reference to the drawings.

According to the exemplary embodiments of the disclosure, since in the case that a lot of block skips occur inside a frame, a bit rate with respect to an intra frame can be relatively increased, and an overall image quality of a picture group being encoded is improved.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

What is claimed is:

1. A rate control encoding method, executed by an encoding device, using skip mode information, the method comprising:
calculating a skip mode occurrence frequency with respect to frames inside a window previous to a current window;
comparing the calculated skip mode occurrence frequency with a reference value;
allocating, when the calculated skip mode occurrence frequency exceeds the reference value, an allocation number of bits with respect to an intra frame inside the current window that is more than an initial target number of bits and then encoding frames inside the current window; and
allocating, when the calculated skip mode occurrence frequency does not exceed the reference value, the allocation number of bits with respect to the intra frame to be equal to the initial target number of bits and then encoding the frames inside the current window.

2. The rate control encoding method of claim 1, wherein the frames inside the previous window comprise a P frame.

3. The rate control encoding method of claim 1, wherein the frames inside the previous window comprise a B frame.

4. The rate control encoding method of claim 1, wherein the skip mode occurrence frequency is with respect to blocks of the frames inside the previous window.

5. The rate control encoding method of claim 1, wherein the current window and the previous window comprise a plurality of P frames, B frames, and intra frames.

6. The rate control encoding method of claim 1, wherein the calculation of the skip mode occurrence frequency is performed after receiving scene change information.

7. The rate control encoding method of claim 1, wherein a comparison of the calculated skip mode occurrence frequency and the reference value is executed by checking whether a result value obtained by adding an average of a skip mode occurrence frequency to a value obtained by multiplying the number of bits per block inside a frame by a given scaling factor exceeds a predetermined threshold value.

8. The rate control encoding method of claim 1, wherein when the allocation number of bits is more than the initial target number of bits, a quantization parameter is lowered.

9. The rate control encoding method of claim 1, wherein when the allocation number of bits is equal to the initial target number of bits, a quantization parameter is maintained at an initial setting value.

10. The rate control encoding method of claim 1, wherein in the case that the calculated skip mode occurrence frequency exceeds the reference value, the allocation number of bits with respect to the intra frame inside the current window increases and an allocation number of bits with respect to other frames, except the intra frame inside the current window, decreases.

11. An encoding device comprising:
a bit rate predictor that allocates all of a target number of bits with respect to a current window and a target number of bits of an intra frame;
a processor that calculates a skip mode occurrence frequency with respect to frames inside a window previous to the current window, compares the calculated skip mode occurrence frequency with a reference value, and allocates an allocation number of bits with respect to the intra frame inside the current window that is higher than an initial target number of bits of the intra frame in the case that the calculated skip mode occurrence frequency exceeds the reference value; and
an encoding rate controller that generates a quantization parameter with respect to each block of frames inside the current window according to the allocation number of bits allocated by the processor.

12. The encoding device of claim 11, wherein the skip mode occurrence frequency is with respect to blocks of P frames or B frames inside the previous window.

13. The encoding device of claim 11, further comprising an encoder that encodes the intra frame according to the generated quantization parameter.

14. The encoding device of claim 11, wherein the processor, when comparing the calculated skip mode occurrence frequency with the reference value, checks whether a resulting value obtained by adding an average of the skip mode occurrence frequency to a value obtained by multiplying the number of bits per block inside a frame of the previous window by a given scaling factor exceeds a predetermined threshold value.

15. The encoding device of claim 11, wherein the encoding device is embodied by a system on chip.

16. An encoding method executed by an encoding device, the method comprising:
a) determining a skip mode occurrence frequency with respect to frames inside a window encoded previous to a current window;
b) allocating, when the determined skip mode occurrence frequency exceeds a predetermined value, a number of bits for a frame inside the current window that greater than a predetermined number of bits; and
c) encoding frames inside the current window using the allocated number of bits, when the determined skip mode occurrence frequency exceeds the predetermined value.

17. The method of claim 16, wherein the skip mode occurrence frequency is determined by summing an average number of skips per block for each of the frames of the previous window and dividing the sum by the number of frames of the previous window.

18. The method of claim 16, wherein operations (a) through (c) are executed only for an intra frame.

19. The method of claim 18, wherein operations (a) through (c) are executed only for a second window and subsequent windows of the intra frame.

20. The method of claim 16, further comprising encoding the frames inside the current window using the predetermined number of bits, when the determined skip mode occurrence frequency does not exceed the predetermined value.
